(19) United States
(12) Patent Application Publication
(10) Pub. No.: US 2016/0009033 A1
(43) Pub. Date: Jan. 14, 2016

(54) Method and Resulting Product of Thermoplastic Material Comprising a Fibre Reinforcement

(71) Applicant: Polytec Composites NL B.V., Roosendaal (NL)

(72) Inventors: Rogier Theodorus Siardus Maria Mandos, Roosendaal (NL); Willem Francois Van Gilst, Goes (NL); Richard Marinus Antonius De Vries, Zundert (NL); Martijn Jacobus De Koning, Ossendrecht (NL)

(21) Appl. No.: 14/764,835

(22) PCT Filed: Jan. 31, 2014
(86) PCT No.: PCT/NL2014/050057

§ 371 Date: Jul. 30, 2015

(30) Foreign Application Priority Data
Jan. 31, 2013 (NL) 2010212

(51) Int. Cl. B29C 70/46; B29C 70/68

(52) U.S. Cl. CPC B29C 70/46; B29C 70/68; B29C 70/683; B29K 2701/12

(57) ABSTRACT

The present invention relates to a method of manufacturing a thermoplastic product in a mould comprising at least two opposing mould parts defining a cavity to at least one of press mould and injection mould the product from thermoplastic material. The method comprises providing a fiber reinforced sheet of a fiber fabric encapsulated in a thermoplastic resin, forming the fiber reinforced sheet in correspondence with a shape of the product and arranging the formed fiber reinforced sheet on and connected close fittingly to an outer surface of the product. The method further entails dividing the fiber reinforced sheet in portions in shape optimized for low cut losses, said shapes being from the group at least comprising rectangles, squares and honeycomb or six-cornered shapes, and welding two or more fiber reinforced sheets or portions thereof together, prior to forming the combined fiber reinforced sheet in correspondence with a shape of the product. Further more the invention relates to a product, comprising a layer of thermoplastic material and a reinforcement, wherein the reinforcement comprises at least one fiber reinforced sheet and is arranged on and connected close fittingly to an outer surface of the layer.

The present invention relates to a product of thermoplastic material, comprising a reinforcement, and a method of manufacturing the same.

It is admittedly known from e.g. WO-2005/118263 and/or EP-1996388 to arrange a textile structure of reinforcing elements of for instance steel cords inside a thermoplastic material product. The cords may be interconnected using a weave of threads or wires to ensure positioning of the cords relative to one another. In such prior art configurations the reinforcing element were always arranged centrally inside the thermoplastic material products.

These prior art reinforcements exhibit the disadvantage that the thermoplastic material, in which the reinforcement is arranged, are still required to have a considerable strength in many respects, such as tensile strength and impact resistance, if used in for instance automobiles. If the thermoplastic base material of the products surrounding the cords is too brittle, it will disintegrate on impact, lying bare the reinforcement arranged therein, such as the cord, which are then fully loaded by external forces, where these reinforcements are not designed to withstand such forces on their own, i.e. without the encapsulating thermoplastic material. If it is too rigid, it will snap. If the thermoplastic material of the product is too weak, it will provide insufficient support for the reinforcement.

Alternatively, it has been known in the art to be an option to employ reinforcement cord or fibers that are suitable for reinforcement purposes, and disperse these homogenously in the thermoplastic material product. However, the costs of such a configuration make this option unviable both commercially and technically.

Additionally reference is made here to the publication FR-2.763.546 as the closest prior art, relative to which at least some of the properties, features, aspects and/or elements in the appended independent claims are novel and involve inventiveness.

The present invention is directed at resolving or at least reducing such problems of the prior art products, by providing a product and a method. The method relates to manufacturing a thermoplastic product in a mould comprising at least two opposing mould parts defining a cavity to at least one of press mould and injection mould the product from thermoplastic material, the method comprising: providing a fiber reinforced sheet of a fiber fabric encapsulated in a thermoplastic resin; forming the fiber reinforced sheet in correspondence with a shape of the product; and arranging the formed fiber reinforced sheet on and connected close fittingly to an outer surface of the product.

According to the invention, with a method according thereto, the precise choice of thermoplastic material for the product becomes much less critical for ensuring durability of the product, even if the product is an impact absorbing element like a bumper or the like. Also for cladding protective or sound absorbing elements and the like, similar or the same benefits can be attained. The traditional product is, as a consequence of the invention, reduced in significance to no more than a carrier for the fiber reinforced sheet (or sheets); a filler to provide body, but where the mechanical properties of the resulting combined product essentially depend on the fiber reinforced sheet (or sheets). Thus material chosen for this carrier/filler, that is comparable in shape and form to the traditional product, can be manufactured from far cheaper materials than previously considered feasible or achievable.

IT is further to be noted that fibers in the fiber reinforced sheet (or sheets) do not need be interconnected or arranged in a weave to maintain the fibres in a predetermined position, in the prior art preferably centrally in the interior of the moulded products. In contrast, the arrangement of these fibres in the sheet (or sheets) on the surface of the thermoplastic material products allow for the fibers to be non-woven, and/or can comprise parallel fibers, et cetera. Thereby a further reduction in costs can be achieved, while desired mechanical properties can be achieved without expensive interweave measures like in the above mentioned prior art disclosures.

It is noted here that even in applications based on press moulding, no flow of the thermoplastic material for the basic product is required. For instance when applying the present invention to a process of forming LWRT—a fluffy type of compressible and formable material having acoustic and sound damping properties—additional strength and rigidity can be imparted to a resulting product, essentially without diminishing the damping properties of the LWRT base material for the resulting combined product.

Further, the sheet (or sheets) are fixed to the traditional product, otherwise the desired mechanical (including acoustical) properties may not be achieved. This fixation will normally result from fusing, where the sheet (or sheets) bond with the surface of the product, but other mechanisms are expressly not excluded from the present invention.

Additionally, according to the present invention, the method exhibits the feature of dividing the fiber reinforced sheet in portions in shape optimized for low cut losses, said shapes being from the group at least comprising rectangles, squares and honeycomb shapes. This contributes to minimization of cut losses. Additionally, the method according to the invention exhibits the feature of welding or otherwise joining two or more fiber reinforced sheets together, prior to forming the combined fiber reinforced sheet in correspondence with a shape of the product. Thereby, cohesion of otherwise loose fiber reinforced sheets of plates can be provided.

The present invention has a multitude of further preferred embodiments, some of which are defined in the appended dependent claims as follows.

In a preferred embodiment the method according to the invention may exhibit the feature of comprising performing the steps of forming the fiber reinforced sheet and arranging the deformed sheet on the product essentially simultaneously, for example during moulding of the product. The huge advantage of the invention in general and this embodiment in particular is that an essentially singular process step allows for the manufacture of the reinforced product.

In a preferred embodiment the method according to the invention may exhibit the feature that the step of providing the fiber reinforced sheet comprises arranging the fiber reinforced sheet against a mould cavity surface of one of the mould parts. Also in this embodiment it is noted that thereby a formation of the reinforcement in conjunction with the thermoplastic base material allows for a robust ad elegant and simple realization of the benefits according to the invention.

In an embodiment having both immediately above described preferred features, the method may exhibit the further feature of arranging the fiber reinforced sheet between a pill of thermoplastic material and the mould cavity surface of said one of the mould parts. In such a very practical embodiment, the method results in moulding of the thermoplastic base material together with the sheet to create a laminate. Such an embodiment may exhibit the feature of further comprising arranging an additional fiber reinforced sheet between the pill of thermoplastic material and a mould cavity surface of the other one of the mould parts. Thus a sandwich may be created, wherein the thermoplastic material is enclosed between the fiber reinforced sheets. Thereby a better resistance to effects of shrink may be achieved.

It is possible to arrange different types of fiber reinforced sheet on opposing sides of the product. For instance, sheets on opposing sides of the product may augment or complement one another to achieve desired mechanical properties of the resulting assembled product. On opposing sides of the product, sheets incorporating different types of fibers can be arranged. Fiber orientations can be made to vary between the sheets on opposing surfaces of the product. For instance the fiber orientations of the fibers in the separate fiber reinforced sheets may be arranged to cross at an angle. The thermoplastic resin in which the fibers are incorporated may be made to vary between sheets on opposition sides on the product. The mechanical properties of the resulting product with different types of fiber reinforced sheets on opposing sides of the core material of the sheets can be designed freely by the skilled person. For instance glass and aramide fibers may be employed in or for sheets on a side or surface of the product more affected by impact or pressure, while steel and carbon fibers may prove to be more suitable to withstand tensile forces to enhance the tensile strength of the resulting product on a side more subjected to pulling forces.

In an embodiment exhibiting the features in the immediately preceding two paragraphs, the method may exhibit the further feature of pre-assembling the pill of thermoplastic material and at least one fiber reinforced sheet, prior to entering the pre-assembly into the mould. This enables a very efficient method.

In a preferred embodiment the method according to the invention may exhibit the feature that arranging the fiber reinforced sheet comprises locally arranging the fiber reinforced sheet on selected portions of the outer surface of the product. This enables the manufacturer to save on relatively expensive fiber reinforced sheet and to only apply the sheet where required. Further this embodiment allows for square or rectangular cuttings to minimize waste. Other shapes of cuttings also naturally also possible, where it is noted that the shape of such cutting is only preferably chosen to minimize cut losses.

In a preferred embodiment the method according to the invention may exhibit the feature that arranging the fiber reinforced sheet comprises arranging double or crossing fiber reinforced sheets on the outer surface of the product. In this embodiment, extra strength may be achieved at mounting points and/or through holes for inserting mounting means, like screws and bolts. Different types of fiber reinforced sheet are possible on top of each other. Likewise different fiber orientations of the superposed and possibly even crossing fiber reinforced sheets are possible

In a preferred embodiment the method according to the invention may exhibit the feature of further comprising pre-heating the fiber reinforced sheet, prior to arranging the fiber reinforced sheet on the outer surface of the product. In as far as differences occur between required heating of the sheet and the product, these can be equalized using the pre-heating of the fiber reinforced sheet.

Additionally, as noted above, the present invention relates in another aspect to a product, comprising a layer of thermoplastic material and a reinforcement, wherein the reinforcement comprises at least one fiber reinforced sheet and is arranged on and connected close fittingly to an outer surface of the layer, wherein the fiber reinforced sheet is divided into portions in at least one shape optimized for low cut losses, said shapes being from the group at least comprising rectangles, squares and honeycomb or six-cornered shapes, and wherein two or more fiber reinforced sheets are welded together. Fiber reinforced sheets are preferably welded or otherwise joined together prior to pressing or injection moulding to improve cohesion of the sheets, or of portions thereof, relative to embodiments, wherein sheets or portions thereof are loosely arranged in a press or injection mould, and thereby restrict the possibility of displacement of the sheets or the portions thereof in the mould.

In a preferred embodiment the product according to the invention may exhibit the feature that the fiber reinforced sheet comprises essentially continuous fibers, preferably or just by way of example an Organo sheet or otherwise sometimes referred to as Organoblech, such as Tepex® from Bond Laminates GmbH.

In a preferred embodiment the product according to the invention may exhibit the feature that fiber components of the fiber reinforced sheet comprises at least one type of fibers from the group, which at least comprises: steel cords; natural fibers; glass fibers; carbon fibers; and aramid fibers.

In a preferred embodiment the product according to the invention may exhibit the feature that the thermoplastic material of the product is at least one relatively inexpensive material from the group comprising GMT, D-LFT, LWRT, and recycle material.

All combinations of features are considered feasible within the disclosure of the present invention herein.

After the foregoing general indication of the invention and preferred embodiments thereof, referring to the appended claims, herein below a description follows of the appended drawing, where specific non-limiting embodiments of the invention are disclosed in more detail. The appended drawing and the description thereof are, however, by no means to be interpreted as more limiting on the scope of protection for the present invention then the appended claims, and additional and alternative embodiments are expressly not excluded from the scope of protection merely in view of any differences with the appended drawings and the description thereof. In the drawing:

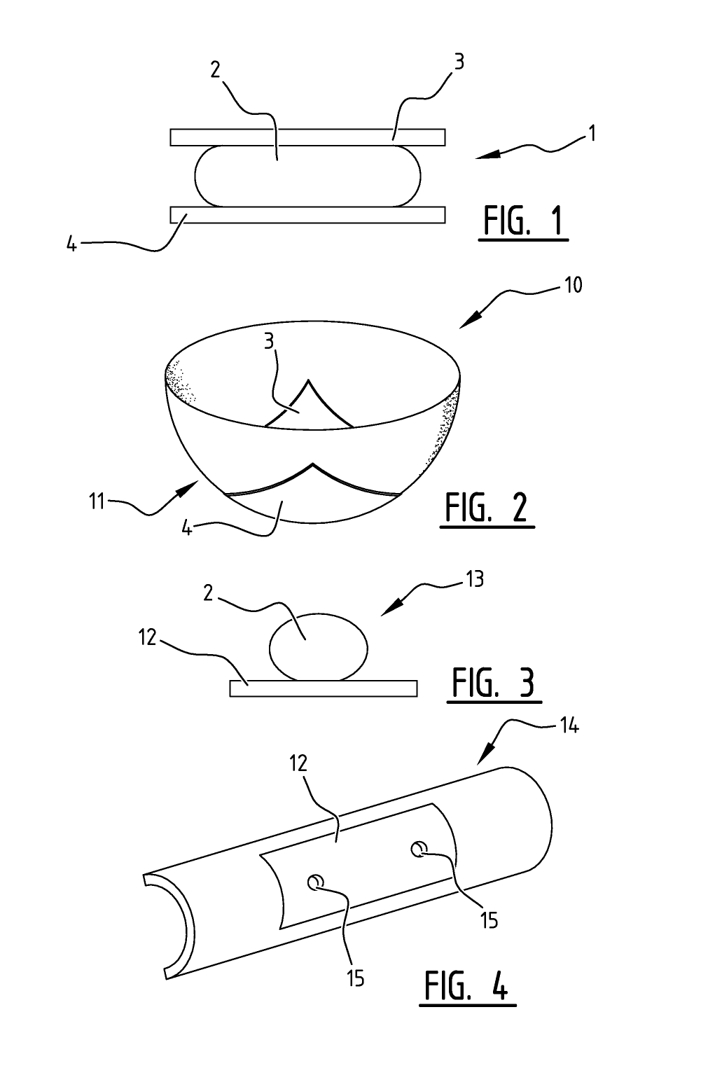

FIG. 1 shows a sandwich according to the present invention, prior to being arranged in a mould;

FIG. 2 shows a bowl, capable of being formed from the pill according to FIG. 1;

FIG. 3 shows an alternative two layer laminate embodiment relative to the sandwich of FIG. 1;

FIG. 4 shows a pipe section, capable of being formed from the two layer laminate according to FIG. 3 with one sided reinforcement;

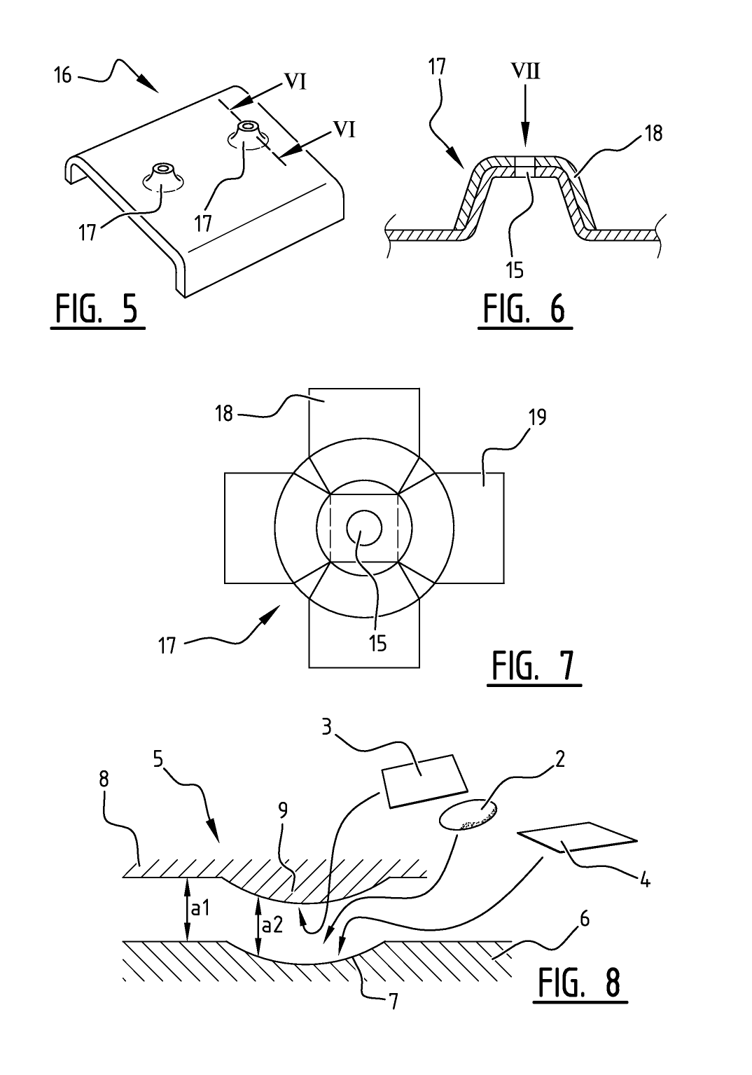

FIGS. 5, 6 and 7 show in respective views cover plate with mountings for mounting the cover plate, where the mountings are reinforced superficially, according to the present invention; and

FIG. 8 shows a schematic view of a method for assembling a product according to the present invention.

In FIG. 1 sandwich 1 is shown, comprising a quantity of thermoplastic material 2, with an upper fiber reinforced sheet 3 and a lower fiber reinforced sheet 4. This sandwich 1 is prepared before introduction thereof into a mould, for instance a press mould 5, like the one shown in FIG. 8. Alternatively, and as shown in FIG. 8, the sheets 3, 4 and the quantity of thermoplastic material to can be introduced separately into the mould 5.

Irrespective of whether the sandwich 1 of FIG. 1 is introduced or the separate components thereof are inserted in correspondence with the schematic representation of FIG. 8, a lower mould part 6 has a depression 7 and an upper mould part 8 has a protrusion 9. In an opened state of the mould 5, the distance a2 is smaller than the distance a1, to define a bowl shaped cavity between the lower mould part 6 and the upper mould part 8. A bowl shaped product 10, as shown in FIG. 2, can thus be manufactured in the mould 5. The bowl 10 in FIG. 2 has the considerably more articulated shape and form than the schematic representation of FIG. 8, and a bottom 11 of the ball 10 is reinforced by the fiber reinforced sheets 3, 4. As indicated above, the sandwich 1 can be pre produced and inserted into the mould 5, or sheet 3 can be applied against the protrusion 9 of the upper mould 8 and sheet for can be applied in the depression 7 of the law mould part 6. Any measure or step can be taken to ensure that the sheets 3, 4 and here to the protrusion 9 and depression 7, respectively. In an opened state of the mould 5 a quantity of thermoplastic material 2 can be introduced into the mould, at least partially between the sheets 3, 4. It will be immediately evident, that the sheets 3, 4 in the final product of the bowl 10 are arranged on or at most in the outer surfaces of the resulting product or bowl 10, which is meant to include the bottom surface of the bowl 10, where the sheet 3 is arranged.

FIGS. 3 and 4 show an alternative embodiment of a similar quantity of thermoplastic material 2, which is arranged on a single fiber reinforced sheet 12. Consequently, the two layer laminate 13 is pre-produced. In a similar fashion as described in conjunction with and through reference to FIG. 8, such a pre-produced two layer laminate 13 can be introduced into a mould 5 in an opened state. Alternatively, the single sheet 12 and quantity of thermoplastic material 2 can be individually and sequentially introduced into the open mould 5. FIG. 4 shows a pipe section 14, capable of being formed from the two layer laminate 13 according to FIG. 3 with one sided reinforcement provided by sheet 12. Naturally, to manufacture this pipe section 14, a different mould needs to be employed than the one of FIG. 8.

Additionally, it is noted here that the fiber reinforced sheet 12 is arranged at the particular location on the pipe section 14 in view of required are desired reinforcement of the pipe section 14, which may have become necessary through the application of holes 15. At the position of the holes 15, the fiber reinforced sheet 12 provides additional support for the pipe section 14, in particular if for example the holes 15 are used to accommodate mounting means such as bolts or screws.

FIGS. 5, 6 and 7 show in respective views a cover plate 16 with mountings 17 for mounting the cover plate 16, where the mountings 17 are reinforced superficially, according to the present invention. At the location of the mountings 17, as indicated in the cross sectional view of FIG. 6, fiber reinforced sheet 18 can be provided on or in the surface of the cover plate 16 at the location of the mounting 17, where at the top of the mounting 17 through a hole 15 is provided to allow accommodation of bolts, screws and other not-shown mounting means. From the top few according to FIG. 7 it becomes apparent that not only sheet 18 is provided, but also an additional sheet 19, which is also, like sheet 18, fiber reinforced. Together, sheets 18, 19 reinforced the mounting 17 for accommodating in a through a hole 15 thereof any suitable mounting means, such as bolts and screws. In this particular instance, the separate fiber reinforced sheets 18, 19 are arranged in a crossing manner on the same side of the resulting product.

It should be noted here, that the present invention can be embodied to exhibit numerous additional and/or alternative features relative to the specific figure description above, referring to the appended drawing, but that such further embodiments and additional and/or alternative features must be considered to reside within the scope of protection for the present invention in as far as these features still comply with the requirements of the invention according to the definition in the appended claims. Alternatives relative to the drawings as well as obvious alternatives relative to the claims are considered to fall within the scope of protection.

1. A method of manufacturing a thermoplastic product in a mould comprising at least two opposing mould parts defining a cavity to at least one of press mould and injection mould the product from thermoplastic material, the method comprising:
providing a fiber reinforced sheet of a fiber fabric encapsulated in a thermoplastic resin;
forming the fiber reinforced sheet in correspondence with a shape of the product; and
arranging the formed fiber reinforced sheet on and connected close fittingly to an outer surface of the product,
wherein the method further comprises:
dividing the fiber reinforced sheet in portions in shape optimized for low cut losses, said shapes being from the group at least comprising rectangles, squares and honeycomb or six-cornered shapes, and
joining two or more fiber reinforced sheets or portions thereof together, for example by welding, prior to forming the combined fiber reinforced sheet in correspondence with a shape of the product.

2. The method according to claim 1, comprising performing the steps of forming the fiber reinforced sheet and arranging the deformed sheet on the product essentially simultaneously, for example during moulding of the product.

3. The method according to claim 1, wherein the step of providing the fiber reinforced sheet comprises arranging the fiber reinforced sheet against a mould cavity surface of one of the mould parts.

4. The method according to claim 2, comprising arranging the fiber reinforced sheet between a pill of thermoplastic material and the mould cavity surface of said one of the mould parts.

5. The method according to claim 4, further comprising arranging an additional fiber reinforced sheet between the pill of thermoplastic material and a mould cavity surface of the other one of the mould parts.

6. The method according to claim 5, comprising arranging different types of fiber reinforced sheet on opposing mould cavity surfaces to be arranged on opposing sides of the product.

7. The method according to claim 4, comprising pre-assembling the pill of thermoplastic material and at least one fiber reinforced sheet, prior to entering the pre-assembly into the mould.

8. The method according to claim 1, wherein arranging the fiber reinforced sheet comprises locally arranging the fiber reinforced sheet on selected portions of the outer surface of the product.

9. The method according to claim 1, wherein arranging the fiber reinforced sheet comprises arranging double or crossing fiber reinforced sheets on the outer surface of the product.

10. The method according to claim 1, further comprising pre-heating the fiber reinforced sheet, prior to arranging the fiber reinforced sheet on the outer surface of the product.

11. A product, comprising a layer of thermoplastic material and a reinforcement, wherein the reinforcement comprises at least one fiber reinforced sheet and is arranged on and connected close fittingly to an outer surface of the layer
wherein
the fiber reinforced sheet is divided into portions in at least one shape optimized for low cut losses, said shapes being from the group at least comprising rectangles, squares and honeycomb or six-cornered shapes, and
wherein two or more fiber reinforced sheets or portions thereof are welded together.

12. The product according to claim 11, wherein the fiber reinforced sheet comprises essentially continuous fibers, preferably a sheet such as Tepex® from Bond Laminates GmbH, and/or Organoblech in general.

13. The product according to claim 11, wherein fiber components of the fiber reinforced sheet comprises at least one type of fibers from the group, which at least comprises: steel cords; natural fibers; carbon fibers; glass fibers; and aramid fibers.

14. The product according to claim 11, wherein the thermoplastic material of the product is at least one relatively inexpensive material from the group comprising GMT, D-LFT, LWRT and recycle material.

15. The product according to claim 11, wherein the portions of fiber reinforced sheet or portions thereof are welded together, prior to forming the combined fiber reinforced sheet, in correspondence with a shape of the product.
